(19) United States
(12) Patent Application Publication
(10) Pub. No.: US 2026/0274536 A1
(43) Pub. Date: Sep. 17, 2026

(54) BIOFUNCTIONAL DATE SEED DERIVED CARBON QUANTUM DOTS LOADED BIOPOLYMER FILM FOR MUSHROOM PRESERVATION

(71) Applicant: Khalifa University of Science and Technology, Abu Dhabi (AE)

(72) Inventors: Fawzi Banat, Abu Dhabi (AE); Sai Kumar Tammina, Abu Dhabi (AE); Raghad Shehaedeh Hussain Abdel Rahman, Abu Dhabi (AE); Arshied Manzoor, Abu Dhabi (AE); Vengatesan Muthukumaraswamy Rangaraj, Abu Dhabi (AE)

(21) Appl. No.: 19/079,089

(22) Filed: Mar. 13, 2025

(51) Int. Cl. B65D 65/46; B82Y 20/00; B82Y 40/00; C01B 32/15; C09K 11/65

(52) U.S. Cl. CPC B65D 65/466; C01B 32/15; C09K 11/65; B82Y 20/00; B82Y 40/00; C01P 2004/64; C01P 2006/60

(57) ABSTRACT

Provided are new food packaging materials and methods of making new food packaging materials using alginate incorporated with carbon quantum dots (CQDs) derived from date seeds. The date seed-derived CQDs, synthesized via a hydrothermal process, exhibit luminescence, hydrophilicity, antioxidant, and antimicrobial properties. When incorporated into alginate films at varying concentrations, the CQDs significantly enhance the flexibility, controlled water vapor transmission, and functional attributes of the packaging material film. In some embodiments, the CQD-loaded films effectively preserve mushrooms at room temperature for seven days, preventing spoilage by regulating gas exchange and minimizing moisture buildup. This sustainable, biodegradable new food packaging material overcomes the limitations of conventional polyethylene films, which foster spoilage and environmental harm. This invention provides a cost-effective, environmentally friendly solution to extend the shelf life of perishable foods while leveraging biological waste for advanced, high-performance food packaging materials.

### FIELD OF THE INVENTION

The present invention relates to biodegradable and food packaging films, specifically alginate-based films embedded with carbon quantum dots (CQDs), including those derived from date seed. These films are designed to preserve perishable items and address challenges associated with food perishability, while also offering enhanced environmental sustainability.

### BACKGROUND OF THE INVENTION

With the increasing global emphasis on sustainability, the food packaging industry has witnessed a significant shift from conventional petroleum-based plastics to biodegradable alternatives. Single-use plastics, such as polyethylene (PE) films, dominate the current packaging market due to their affordability, flexibility, and durability. However, their long degradation times, environmental persistence, and reliance on non-renewable fossil fuels have made them a major contributor to plastic pollution. Improper disposal of PE-based packaging materials exacerbates environmental concerns, posing risks to ecosystems and human health.

Biodegradable packaging materials, such as those based on biopolymers, have emerged as a promising alternative to mitigate these environmental issues. Biopolymers are derived from renewable resources such as starch, cellulose, chitosan, and alginate. These materials are not only biodegradable but also offer advantages such as recyclability and reduced carbon footprints. However, despite these benefits, biopolymers inherently possess limitations, including: lower mechanical strength, reduced flexibility, and inadequate barrier properties for oxygen and moisture compared to conventional plastics. These shortcomings restrict their widespread application, particularly for packaging highly perishable food items that require stringent preservation conditions.

For example, mushrooms, including Agaricus bisporus, Boletus edulis, and Cantharellus spp., are widely consumed due to their rich nutritional profile, delicate flavor, and health benefits. However, their high-water content, rapid respiration rate, and susceptibility to microbial contamination make them among the most perishable food products. At room temperature, mushrooms typically spoil within 1 to 3 days due to factors such as dehydration, texture degradation, discoloration, and the development of unpleasant odors. These challenges are further amplified in wholesale and consumer markets, where improper storage conditions often accelerate the spoilage process.

Conventional mushroom packaging solutions, such as polyethylene (PE) films, are widely used due to their cost-effectiveness and moisture resistance. However, PE films exhibit several significant limitations including that PE films are unable to effectively regulate the exchange of gases such as oxygen and carbon dioxide, leading to the rapid spoilage of mushrooms under anaerobic conditions. Additionally, PE films have high moisture accumulation which promotes the growth of mold and bacteria, compromising food safety and quality. And lastly, PE is derived from non-biodegradable fossil fuels which contributes significantly to plastic pollution, raising sustainability concerns.

Recent advancements in biopolymer-based edible packaging have shown promise in addressing these limitations. For instance, biopolymer films have been successfully enhanced with active agents, such as antioxidants and antimicrobials, to extend the shelf life of fresh produce. However, the scalability and cost-effectiveness of these solutions remain significant challenges.

There remains a critical need for cost-effective, biodegradable packaging materials capable of extending the shelf-life of food products while addressing the limitations of existing biopolymer films. Specifically, there is a need for packaging solutions that offer controlled oxygen and moisture barrier properties, promising antimicrobial and antioxidant functions, and the ability to maintain food quality at ambient temperatures. Furthermore, leveraging sustainable and abundant bio-waste materials, such as date seeds, as sources for active nanofillers provides an eco-friendly and economically viable pathway for developing such packaging materials.

### BRIEF SUMMARY OF THE INVENTION

Covered embodiments of the invention are defined by the claims, not this summary. This summary is a high-level overview of various aspects of the invention and introduces some of the concepts that are further described in the figures and in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

The present invention relates to a novel biodegradable and food packaging material designed to address the dual challenges of food preservation and environmental sustainability. Specifically, the invention focuses on the development of an alginate-based biopolymer film integrated with carbon quantum dots (CQDs) derived from date seed powder (DSP). By combining the inherent benefits of renewable biopolymers and the advanced functional properties of CQDs, the invention offers a high-performance packaging solution for extending the shelf-life of highly perishable foods, such as fruits, and vegetables, while reducing the reliance on conventional plastic packaging.

Disclosed are a new, packaging material comprising: carbon quantum dots; and a biopolymer matrix; wherein the carbon quantum dots are uniformly dispersed within the biopolymer matrix; and wherein the packaging material is biodegradable. In some non-limiting examples, the packaging material can include wherein the carbon quantum dots comprise a particle size from 1 to 10 nm. In some further non-limiting examples, the carbon quantum dots comprise an excitation-dependent fluorescence with a maximum emission intensity from 300 to 500 nm. In some further non-limiting examples, the carbon quantum dots comprise an excitation energy from 200 to 400 nm. In some further non-limiting examples, the carbon quantum dots are derived from a date seed. In some further non-limiting examples, the biopolymer matrix comprises an alginate. In some further non-limiting examples, the packaging material has a thickness from 50 μm to 100 μm.

Also disclosed herein are methods for producing a packaging material. A method of producing the packaging material can include: synthesizing carbon quantum dots using a hydrothermal process; incorporating the carbon quantum dots into a biopolymer matrix comprising an alginate to form a carbon quantum dots-loaded biopolymer solution; casting the carbon quantum dots-loaded biopolymer solution onto a PTFE-coated glass plate; and dried the cast solution to produce a packaging material film. In some non-limiting examples, the carbon quantum dots are derived from a date seed. In some further non-limiting examples, the carbon quantum dots are synthesized by subjecting the date seed to the hydrothermal process at a temperature from 100 to 200° C. In some further non-limiting examples, the hydrothermal process is conducted for a duration from 1 to 24 hours. In some further non-limiting examples, the carbon quantum dots are incorporated into the biopolymer matrix at a concentration from 2 to 6% by weight relative to the weight of the alginate. In some further non-limiting examples, the method further comprises dispersing the carbon quantum dots uniformly into the biopolymer matrix using mechanical stirring. In some further non-limiting examples, the cast solution drying process is conducted at room temperature, such as from 22 to 25° C. In some further non-limiting examples, the cast solution drying process is conducted for a duration from 48 to 72 hours. In some further non-limiting examples, the packaging material has a thickness selected from 50 μm to 100 μm. In some further non-limiting examples, the packaging material film is biodegradable.

Also disclosed herein are methods of preparing a packaging material. A method for preparing a packaging material, the method comprising: subjecting a date seed to a hydrothermal process to synthesize carbon quantum dots; dispersing the carbon quantum dots into a biopolymer matrix comprising an alginate to form a carbon quantum dots-loaded biopolymer solution; casting the carbon quantum dots-loaded biopolymer solution onto a PTFE-coated glass plate and dried the cast solution to develop a packaging material. In some non-limiting examples, the carbon quantum dots are synthesized by subjecting the date seed to the hydrothermal process at a temperature from 100 to 200° C. In some further non-limiting examples, the hydrothermal process is conducted for a duration from 1 to 24 hours. In some further non-limiting examples, wherein the carbon quantum dots are incorporated into the biopolymer matrix at a concentration from 2% to 6% by weight relative to the weight of the alginate. In some further non-limiting examples, the method comprises dispersing the carbon quantum dots uniformly into the biopolymer matrix using mechanical stirring. In some further non-limiting examples, the cast solution drying process is conducted at room temperature. In some further non-limiting examples, the cast solution drying process is conducted for a duration from 48 to 72 hours. In some further non-limiting examples, the packaging material has a thickness selected from 50 μm to 100 μm. In some further non-limiting examples, the packaging material film is biodegradable.

Also disclosed herein are methods for preserving biological products. A method for preserving a biological product, the method comprising: subjecting a date seed to a hydrothermal process to synthesize carbon quantum dots; dispersing the carbon quantum dots into a biopolymer matrix comprising an alginate to form a carbon quantum dots-loaded biopolymer solution; casting the carbon quantum dots-loaded biopolymer solution onto a PTFE-coated glass plate and dried the cast solution to develop a packaging material film; packaging the biological product using the packaging material film; and storing a packaged biological product. In some non-limiting examples, the carbon quantum dots are synthesized by subjecting the date seed to the hydrothermal process at a temperature from 100 to 200° C. In some further non-limiting examples, the hydrothermal process is conducted for a duration from 1 to 24 hours. In some further non-limiting examples, the carbon quantum dots are incorporated into the biopolymer matrix at a concentration from 2 to 6% by weight relative to the weight of the alginate. In some further non-limiting examples, the method comprises dispersing the carbon quantum dots uniformly into the biopolymer matrix using mechanical stirring. In some further non-limiting examples, the cast solution drying process is conducted at room temperature. In some further non-limiting examples, the cast solution drying process is conducted for a duration of 48 to 72 hours. In some further non-limiting examples, the packaging material has a thickness from 50 μm to 100 μm. In some further non-limiting examples, the packaging material film is biodegradable. In some further non-limiting examples, the biological product comprises herbs, fruits, and vegetables. In some further non-limiting reactions, the packaging material film exhibits antimicrobial activity against bacterial and fungal pathogens. In some further non-limiting reaction, the bacterial and fungal pathogens comprise Escherichia coli, Staphylococcus aureus, Pseudomonas aeruginosa, Bacillus subtilis, or Candida albicans.

The present invention focuses on the usage of food packaging materials to preserve vegetable such as mushrooms, but the present invention can be used to preserve any herbs, vegetables, and fruits.

The present invention incorporates DSP-derived CQDs into alginate films, creating a multifunctional packaging material that improves food preservation.

The present invention integrates carbon quantum dots (CQDs), synthesized from date seed powder (DSP), into an alginate biopolymer matrix to create a high-performance packaging film. Date seeds are converted into CQDs through a hydrothermal synthesis process, which produces nanomaterials with strong antioxidant and antimicrobial activity, and hydrophilicity and luminescence.

The present invention encompasses embedding DSP-derived CQDs into the alginate film, with the resulting packaging material achieving significant performance improvements, including enhanced flexibility, controlled water vapor permeability, and active functionalities such as radical scavenging and microbial inhibition. These properties enable the film to maintain the freshness and quality of biological products, such as mushrooms, for up to seven days at room temperature, compared to only 1-3 days for conventional packaging solutions.

The present invention has several advantages, such as enhanced food preservation, improved flexibility and controlled water vapor transmission, sustainability and waste valorization, cost-effectiveness and scalability, and preservation.

The present invention enhances food preservation. The CQD-loaded alginate film of the present invention effectively regulates gas exchange and prevents moisture buildup, which are critical factors for extending the shelf-life of biological products and/or perishable items, such as mushrooms. The film's antioxidant properties slow oxidative degradation, while its antimicrobial activity inhibits the growth of spoilage-causing microorganisms.

The present invention has improved the flexibility and controlled barrier properties. The incorporation of CQDs into the invention significantly enhances the flexibility, and controlled water vapor transmission rate (WVTR) of the alginate film. The improvements of the present invention make the resulting film suitable for practical packaging applications, addressing the limitations of traditional biopolymers.

The present invention increases sustainability and waste valorization. By utilizing date seeds—an agricultural waste product—as the raw material for CQDs, the present invention promotes waste valorization. Additionally, the biodegradable nature of the alginate film further reduces environmental impact, offering a sustainable alternative to petroleum-based plastics.

The present invention is also cost-effective and scalable. The present invention leverages abundant, low-cost bio-waste materials and a relatively simple synthesis process, making it economically viable for large-scale production. As such, the present invention addresses one of the major barriers to the commercial adoption of advanced active packaging technologies.

The present invention increases preservation of perishable items. Unlike traditional preservation methods such as modified atmosphere packaging (MAP) or cold storage, which require specialized equipment and high energy consumption, the present invention enables effective preservation at ambient temperatures. This makes the technology particularly suitable for regions with limited access to refrigeration infrastructure.

The invention involves the preparation of CQDs through a hydrothermal process. In this process, date seed powder is mixed with a solution and subjected to high temperatures and pressures in a PTFE-lined autoclave. The resulting CQDs are purified and incorporated into an alginate solution at varying concentrations. The film solution is cast onto a PTFE-coated glass plate and dried to form thin, flexible films. The optimal CQD concentration (6%) was found to exhibit the best performance in terms of extending mushroom shelf life.

The CQD-loaded films were tested against conventional PE films and plain alginate films in mushroom storage studies. Mushrooms packaged with the CQD-loaded films retained their freshness, texture, and color for up to seven days, without developing foul odors or microbial spoilage. In contrast, mushrooms stored in PE packaging exhibited significant spoilage and odor within 48 hours under the same conditions.

While the present invention is specifically designed for mushroom preservation, its potential applications extend to other biological products and/or perishable food items, such as fruits, and vegetables, that require controlled atmospheric conditions and active packaging functionalities. The present invention film's biodegradable and renewable nature also makes it suitable for environmentally conscious consumers and industries.

The present invention represents a significant advancement in the field of sustainable food packaging. By combining the renewable and biodegradable properties of alginate with the multifunctional benefits of CQDs derived from date seed powder, the present invention offers a high-performance, eco-friendly alternative to conventional plastic packaging. This innovation not only addresses the urgent need for effective food preservation but also contributes to global efforts to reduce plastic waste and promote sustainable development.

Other objects and advantages of the invention will be apparent from the following detailed description of non-limiting examples of the invention.

### BRIEF DESCRIPTION OF THE DRAWINGS

FIG. 1 is a schematic representation of the preparation of DS-CQDs loaded alginate films.

FIG. 2A is an emission spectra of DS-CQDs at different wavelengths.

FIG. 2B is an excitation and emission spectra of DS-CQDs.

FIG. 3 is a graph showing the antioxidant activity of DS-CQDs.

FIG. 4A is a graph showing the antioxidant activity of DS-CQD DPPH.

FIG. 4B is a graph showing the antioxidant activity of DS-CQD ABTS assays of DS-CQDs.

FIG. 5 is a set of pictures showing the antimicrobial activity of DS-CQDs via well-diffusion method.

FIG. 6 is a set of pictures showing the antimicrobial activity of DS-CQDs against pathogens.

FIG. 7A is a graph showing the DPPH Antioxidant activity of alginate films with different dosages of DS-CQDs.

FIG. 7B is a graph showing the ABTS Antioxidant activity of alginate films with different dosages of DS-CQDs.

FIG. 8A is a picture showing a neat alginate film (o % DS-CQDs).

FIG. 8B is a picture showing the alginate with DS-CQDs at 2%.

FIG. 8C is a picture showing the alginate with DS-CQDs at 4%.

FIG. 8D is a picture showing the alginate with DS-CQDs at 6%.

FIG. 9 is a set of pictures showing the freshness monitoring of mushrooms in commercial, alginate, and DS-CQDs loaded alginate films.

### DETAILED DESCRIPTION OF THE INVENTION

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” and “the” includes singular and plural references unless the context clearly dictates otherwise.

The term “carbon quantum dots” (CQDs) and the like refers to a class of zero dimensional nanomaterials characterized by their small size, typically less than 10 nanometers in diameter, and unique photoluminescent properties. They are composed primarily of carbon atoms and may include various surface functional groups or dopants, such as oxygen, nitrogen, or sulfur, to modify their physical, chemical, or optical properties. CQDs are known for their excellent biocompatibility, chemical stability, water solubility, and tunable fluorescence, making them valuable in a wide range of applications, including bioimaging, drug delivery, sensing, catalysis, and optoelectronic devices. CQD synthesis can be achieved through top-down methods, such as laser ablation or chemical oxidation of carbon precursors, or bottom-up methods, such as pyrolysis or hydrothermal treatment of organic compounds.

The term “biopolymer matrix” and the like refers to a structured, continuous network or framework composed of natural or synthetic biopolymers, which are macromolecules derived from biological sources such as proteins, polysaccharides, nucleic acids, or other naturally occurring polymers. The matrix provides a physical and chemical environment to encapsulate, embed, or interact with other materials, such as nanoparticles, active compounds, or additives, to achieve specific functional properties. Biopolymer matrices are characterized by their biocompatibility, biodegradability, and renewable origin, making them particularly useful in applications such as drug delivery systems, tissue engineering scaffolds, food packaging, environmental remediation, and biosensors. Examples of biopolymers commonly used in these matrices include cellulose, chitosan, alginate, gelatin, starch, and polylactic acid (PLA). The structural and functional properties of the matrix can be tailored through chemical modification, cross-linking, or the incorporation of additional components to meet the desired performance criteria for specific applications.

The term “date seed” or the like refers to the hard, oval-shaped endosperm found at the center of the fruit of date palms (genus Phoenix, particularly Phoenix dactylifera). Date seeds are composed primarily of cellulose, hemicellulose, lignin, starch, proteins, and lipids, along with trace amounts of minerals and bioactive compounds such as polyphenols and flavonoids.

The term “alginate” or the like refers to a naturally occurring biopolymer derived from the cell walls of brown algae (Phaeophyceae) or produced by certain bacterial species, such as Pseudomonas and Azotobacter. Chemically, alginate is a polysaccharide composed of linear chains of alternating blocks of α-L-guluronic acid (G-blocks) and β-D-mannuronic acid (M-blocks), as well as regions of mixed composition (MG-blocks). The unique composition and ratio of these blocks influence the physical and functional properties of alginate, such as its gel-forming capability in the presence of divalent cations like calcium ions (Ca²⁺).

The term “hydrothermal process” or the like refers to a method of synthesizing, modifying, or processing materials in a sealed environment using water or an aqueous solution as the reaction medium under elevated temperature and pressure conditions. The process typically occurs in a closed system, such as an autoclave or a hydrothermal reactor, which allows water to remain in its liquid phase at temperatures above its normal boiling point. Hydrothermal processes are employed to induce chemical reactions, crystallization, or structural modifications in materials that are otherwise difficult to achieve under ambient conditions.

### INTRODUCTION

The present invention is directed to a packaging material comprising carbon quantum dots (CQDs) and a biopolymer matrix. The CQDs may be uniformly dispersed within the biopolymer matrix. The packaging material may be biodegradable. The material may be especially as a food packaging material. The biopolymer may be an alginate biopolymer. The CQDs may be derived from date seed powder (DSP). In some aspects, the CQDs are uniformly dispersed within the biopolymer matrix using ultrasonic or mechanical stirring. This packaging material, as described herein, may be used as food packaging to preserve food or other biological products. Such products include flowers, fruits vegetables, dairy products, seafood, meet products, medical products, and others. The packaging material may exhibit antimicrobial activity against bacterial and fungal pathogens, including Escherichia coli, Staphylococcus aureus, Pseudomonas aeruginosa, Bacillus subtilis, or Candida albicans.

The present invention is also directed to methods for producing the packaging material described herein. The method may include synthesizing CQDs using a hydrothermal process, incorporating the CQDs into a biopolymer matrix to form a CQD-loaded biopolymer solution, casting the CQD-loaded biopolymer solution onto a substrate to create a cast solution, and drying the case solution to produce a packaging material. The packaging material may be a film. The substrate may be cardboard, plastic, polytetrafluoroethylene (PTFE, i.e., Teflon) coated glass plate or other known substrates, particularly in the food packaging industry.

In some aspects, the methods described herein are specific to using date seeds to synthesize CQDs. Date seeds, a by-product of date fruit consumption, are an abundant and renewable bio-waste resource, particularly in regions like the Middle East and North Africa, where date palm cultivation is widespread. These date seeds are rich in bioactive compounds, including polyphenols, flavonoids, and antioxidants, making them highly valuable for various applications.

Traditionally, date seeds have been underutilized, often discarded or used in low-value applications such as animal feed or compost. However, their chemical composition and structural properties make them a promising raw material for high-value applications, such as the production of CQDs.

CQDs are nanoscale carbon-based materials with unique physicochemical properties, making them highly versatile for a wide range of applications. Typically, smaller than 10 nanometers, CQDs exhibit excellent biocompatibility, luminescence, hydrophilicity, and robust antioxidant and antimicrobial activity. Their photoluminescent properties allow them to emit light at specific wavelengths, making them useful in bioimaging, sensors, and optoelectronics fields. In the context of food packaging, CQDs serve as functional nanofillers that enhance the performance of biopolymer films. CQDs improved flexibility and controlled water vapor permeability while also imparting active functionalities such as antimicrobial and antioxidant activity.

CQDs derived from sustainable biomass sources, such as date seeds, represent an environmentally friendly alternative to synthetic nanomaterials. Their integration into biodegradable packaging materials offers significant potential to extend the shelf-life of perishable foods and reduce reliance on traditional plastic packaging.

In some aspects, the carbon quantum dots comprise a particle size from 1 to 10 nm, e.g., from 1 to 9 nm, from 1 to 8 nm, from 1 to 7 nm, from 1 to 6 nm, from 1 to 5 nm, from 1 to 4 nm, from 1 to 3 nm, from 1 to 2 nm, from, from 2 to 10 nm, from 2 to 9 nm, from 2 to 8 nm, from 2 to 7 nm, from 2 to 6 nm, from 2 to 5 nm, from 2 to 4 nm, from 2 to 3 nm, 3 to 10 nm, from 4 to 9 nm, from 4 to 8 nm, from 4 to 7 nm, from 4 to 6 nm, from 4 to 5 nm, from 5 to 10 nm, from 6 to 10 nm, from 7 to 10 nm, from 8 to 10 nm, from 8 to 10 nm, from 6 to 10 nm, from 6 to 9 nm, from 6 to 8 nm, from 6 to 7 nm, from 7 to 10 nm, from 7 to 9 nm, from 7 to 10 nm, from 8 to 10 nm, from 8 to 9 nm, or from 9 to 10 nm.

In some aspects, the carbon quantum dots comprise an excitation-independent fluorescence with a maximum emission intensity from 300 nm to 500 nm, from 310 to 500 nm, from 320 to 500 nm, from 330 to 500 nm, from 340 to 500 nm, from 350 to 500 nm, from 360 to 500 nm, from 370 to 500 nm, from 380 to 500 nm, from 390 to 500 nm, from 400 to 500 nm, from 410 to 500 nm, from 420 to 500 nm, from 430 to 500 nm, from 440 to 500 nm, from 450 to 500 nm, from 460 to 500 nm, from 470 to 500 nm, from 480 to 500 nm, from 490 to 500 nm, from 300 to 490 nm, from 300 to 480 nm, from 300 to 470 nm, from 300 to 460 nm, from 300 to 450 nm, from 300 to 440 nm, from 300 to 430 nm, from 300 to 420 nm, from 300 to 410 nm, from 300 to 400 nm, from 300 to 390 nm, from 300 to 380 nm, from 300 to 370 nm, from 300 to 360 nm, from 300 to 350 nm, from 300 to 340 nm, from 300 to 330 nm, from 300 to 320 nm, from 300 to 310 nm, from 310 to 490 nm, from 310 to 480 nm, from 310 to 470 nm, from 310 to 460 nm, from 310 to 450 nm, from 310 to 440 nm, from 310 to 430 nm, from 310 to 420 nm, from 310 to 410 nm, from 310 to 400 nm, from 310 to 390 nm, from 310 to 380 nm, from 310 to 370 nm, from 310 to 360 nm, from 310 to 350 nm, from 310 to 340 nm, from 310 to 330 nm, from 310 to 320 nm, from 320 to 490 nm, from 320 to 480 nm, from 320 to 470 nm, from 320 to 460 nm, from 320 to 450 nm, from 320 to 440 nm, from 320 to 430 nm, from 320 to 420 nm, from 320 to 410 nm, from 320 to 400 nm, from 320 to 390 nm, from 320 to 380 nm, from 320 to 370 nm, from 320 to 360 nm, from 320 to 350 nm, from 320 to 340 nm, from 320 to 330 nm, from 330 to 490 nm, from 330 to 480 nm, from 330 to 470 nm, from 330 to 460 nm, from 330 to 450 nm, from 330 to 440 nm, from 330 to 430 nm, from 330 to 420 nm, from 330 to 410 nm, from 330 to 400 nm, from 330 to 390 nm, from 330 to 380 nm, from 330 to 370 nm, from 330 to 360 nm, from 330 to 350 nm, from 330 to 340 nm, from 340 to 500 nm, from 340 to 490 nm, from 340 to 480 nm, from 340 to 470 nm, from 340 to 460 nm, from 340 to 450 nm, from 340 to 440 nm, from 340 to 430 nm, from 340 to 420 nm, from 340 to 410 nm, from 340 to 400 nm, from 340 to 390 nm, from 340 to 380 nm, from 340 to 370 nm, from 340 to 360 nm, from 340 to 350 nm, from 350 to 490 nm, from 350 to 480 nm, from 350 to 470 nm, from 350 to 460 nm, from 350 to 450 nm, from 350 to 440 nm, from 350 to 430 nm, from 350 to 420 nm, from 350 to 410 nm, from 350 to 400 nm, from 350 to 390 nm, from 350 to 380 nm, from 350 to 370 nm, from 350 to 360 nm, from 360 to 500 nm, from 360 to 490 nm, from 360 to 480 nm, from 360 to 470 nm, from 360 to 460 nm, from 360 to 450 nm, from 360 to 440 nm, from 360 to 430 nm, from 360 to 420 nm, from 360 to 410 nm, from 360 to 400 nm, from 360 to 390 nm, from 360 to 380 nm, from 360 to 370 nm, from 370 to 500 nm, from 370 to 490 nm, from 370 to 480 nm, from 370 to 470 nm, from 370 to 460 nm, from 370 to 450 nm, from 370 to 440 nm, from 370 to 430 nm, from 370 to 420 nm, from 370 to 410 nm, from 370 to 400 nm, from 370 to 390 nm, from 370 to 380 nm, from 380 to 490 nm, from 380 to 480 nm, from 380 to 470 nm, from 380 to 460 nm, from 380 to 450 nm, from 380 to 440 nm, from 380 to 430 nm, from 380 to 420 nm, from 380 to 410 nm, from 380 to 400 nm, from 380 to 390 nm, from 390 to 500 nm, from 390 to 490 nm, from 390 to 480 nm, from 390 to 470 nm, from 390 to 460 nm, from 390 to 450 nm, from 390 to 440 nm, from 390 to 430 nm, from 390 to 420 nm, from 390 to 410 nm, from 390 to 400 nm, from 400 to 490 nm, from 400 to 480 nm, from 400 to 470 nm, from 400 to 460 nm, from 400 to 450 nm, from 400 to 440 nm, from 400 to 430 nm, from 400 to 420 nm, from 400 to 410 nm, from 420 to 500 nm, from 420 to 490 nm, from 420 to 480 nm, from 420 to 470 nm, from 420 to 460 nm, from 420 to 450 nm, from 420 to 440 nm, from 420 to 430 nm, from 430 to 490 nm, from 430 to 480 nm, from 430 to 470 nm, from 430 to 460 nm, from 430 to 450 nm, from 430 to 440 nm, from 440 to 500 nm, from 440 to 490 nm, from 440 to 480 nm, from 440 to 470 nm, from 440 to 460 nm, from 440 to 450 nm, from 450 to 500 nm, from 450 to 490 nm, from 450 to 480 nm, from 450 to 470 nm, from 460 to 470 nm, from 470 to 500 nm, from 470 to 490 nm, from 470 to 480 nm, from 480 to 500 nm, from 480 to 490 nm, or from 490 to 500 nm.

In some aspects, the carbon quantum dots comprise an excitation energy from 200 to 400 nm, from 210 to 400 nm, from 220 to 400 nm, from 230 to 400 nm, from 240 to 400 nm, from 250 to 400 nm, from 260 to 400 nm, from 270 to 400 nm, from 280 to 400 nm, from 290 to 400 nm, from 300 to 400 nm, from 310 to 400 nm, from 320 to 400 nm, from 320 to 400 nm, from 330 to 400 nm, from 340 to 400 nm, from 350 to 400 nm, from 360 to 400 nm, from 370 to 400 nm, from 380 to 400 nm, from 390 to 400 nm from 200 to 390 nm, from 210 to 390 nm, from 220 to 390 nm, from 230 to 390 nm, from 240 to 390 nm, from 250 to 390 nm, from 260 to 390 nm, from 270 to 390 nm, from 280 to 390 nm, from 290 to 390 nm, from 300 to 390 nm, from 310 to 390 nm, from 320 to 390 nm, from 320 to 390 nm, from 330 to 390 nm, from 340 to 390 nm, from 350 to 390 nm, from 360 to 390 nm, from 370 to 390 nm, from 380 to 390 nm, from 200 to 380 nm, from 210 to 380 nm, from 220 to 380 nm, from 230 to 380 nm, from 240 to 380 nm, from 250 to 380 nm, from 260 to 380 nm, from 270 to 380 nm, from 280 to 380 nm, from 290 to 380 nm, from 300 to 380 nm, from 310 to 380 nm, from 320 to 380 nm, from 320 to 380 nm, from 330 to 380 nm, from 340 to 380 nm, from 350 to 380 nm, from 360 to 380 nm, from 370 to 380 nm, from 200 to 370 nm, from 210 to 370 nm, from 220 to 370 nm, from 230 to 370 nm, from 240 to 370 nm, from 250 to 370 nm, from 260 to 370 nm, from 270 to 370 nm, from 280 to 370 nm, from 290 to 370 nm, from 300 to 370 nm, from 310 to 370 nm, from 320 to 370 nm, from 320 to 370 nm, from 330 to 370 nm, from 340 to 370 nm, from 350 to 370 nm, from 360 to 370 nm, from 200 to 360 nm, from 210 to 360 nm, from 220 to 360 nm, from 230 to 360 nm, from 240 to 360 nm, from 250 to 360 nm, from 260 to 360 nm, from 270 to 360 nm, from 280 to 360 nm, from 290 to 360 nm, from 300 to 360 nm, from 310 to 360 nm, from 320 to 360 nm, from 320 to 360 nm, from 330 to 360 nm, from 340 to 360 nm, from 350 to 360 nm, from 200 to 350 nm, from 210 to 350 nm, from 220 to 350 nm, from 230 to 350 nm, from 240 to 350 nm, from 250 to 350 nm, from 260 to 350 nm, from 270 to 350 nm, from 280 to 350 nm, from 290 to 350 nm, from 300 to 350 nm, from 310 to 350 nm, from 320 to 350 nm, from 320 to 350 nm, from 330 to 350 nm, from 340 to 350 nm, from 200 to 340 nm, from 210 to 340 nm, from 220 to 340 nm, from 230 to 340 nm, from 240 to 340 nm, from 250 to 340 nm, from 260 to 340 nm, from 270 to 340 nm, from 280 to 340 nm, from 290 to 340 nm, from 300 to 340 nm, from 310 to 340 nm, from 320 to 340 nm, from 320 to 340 nm, from 330 to 340 nm, from 200 to 330 nm, from 210 to 330 nm, from 220 to 330 nm, from 230 to 330 nm, from 240 to 330 nm, from 250 to 330 nm, from 260 to 330 nm, from 270 to 330 nm, from 280 to 330 nm, from 290 to 330 nm, from 300 to 330 nm, from 310 to 330 nm, from 320 to 330 nm, from 200 to 320 nm, from 210 to 320 nm, from 220 to 320 nm, from 230 to 320 nm, from 240 to 320 nm, from 250 to 320 nm, from 260 to 320 nm, from 270 to 320 nm, from 280 to 320 nm, from 290 to 320 nm, from 300 to 320 nm, from 310 to 320 nm, from 200 to 310 nm, from 210 to 310 nm, from 220 to 310 nm, from 230 to 310 nm, from 240 to 310 nm, from 250 to 310 nm, from 260 to 310 nm, from 270 to 310 nm, from 280 to 310 nm, from 290 to 310 nm, from 300 to 310 nm, from 200 to 300 nm, from 210 to 300 nm, from 220 to 300 nm, from 230 to 300 nm, from 240 to 300 nm, from 250 to 300 nm, from 260 to 300 nm, from 270 to 300 nm, from 280 to 300 nm, from 290 to 300 nm, from 210 to 290 nm, from 220 to 290 nm, from 230 to 290 nm, from 240 to 290 nm, from 250 to 290 nm, from 260 to 290 nm, from 270 to 290 nm, from 280 to 290 nm, from 210 to 280 nm, from 220 to 280 nm, from 230 to 280 nm, from 240 to 280 nm, from 250 to 280 nm, from 260 to 280 nm, from 270 to 280 nm, from 210 to 270 nm, from 220 to 270 nm, from 230 to 270 nm, from 240 to 270 nm, from 250 to 270 nm, from 260 to 270 nm, from 210 to 260 nm, from 220 to 260 nm, from 230 to 260 nm, from 240 to 260 nm, from 250 to 260 nm, from 210 to 250 nm, from 220 to 250 nm, from 230 to 250 nm, from 240 to 250 nm, from 210 to 240 nm, from 220 to 240 nm, from 230 to 240 nm, from 210 to 230 nm, from 220 to 230 nm, or from 210 to 220 nm.

In some aspects, the packaging material has a thickness from 50 to 100 μm, from 60 to 100 μm, from 60 to 90 μm, from 60 to 80 μm, from 60 to 70 μm, from 70 to 100 μm, from 70 to 90 μm, from 70 to 80 μm, from 80 to 100 μm, from 80 to 90 μm, or from 90 to μm.

In an example, the carbon quantum dots are synthesized by subjecting the date seed to the hydrothermal process at a temperature from 100 to 200° C., from 110 to 200° C., from 120 to 200° C., from 130 to 200° C., from 140 to 200° C., from 150 to 200° C., from 160 to 200° C., from 170 to 200° C., from 180 to 200° C., from 190 to 200° C., 110 to 190° C., from 120 to 190° C., from 130 to 190° C., from 140 to 190° C., from 150 to 190° C., from 160 to 190° C., from 170 to 190° C., from 180 to 190° C., 110 to 180° C., from 120 to 180° C., from 130 to 180° C., from 140 to 180° C., from 150 to 180° C., from 160 to 180° C., from 170 to 180° C., 110 to 170° C., from 120 to 170° C., from 130 to 170° C., from 140 to 170° C., from 150 to 170° C., from 160 to 170° C., 110 to 160° C., from 120 to 160° C., from 130 to 160° C., from 140 to 160° C., from 150 to 160° C., from 110 to 150° C., from 120 to 150° C., 130 to 150° C., from 140 to 150° C., from 110 to 140° C., from 120 to 140° C., from 130 to 140° C., from 110 to 130° C., from 120 to 130° C., or from 110 to 120° C.

In an example, the hydrothermal process is conducted for a duration from 1 to 24 hours, from 3 to 24 hours, from 5 to 24 hours, from 7 to 24 hours, from 9 to 24 hours, from 11 to 24 hours, from 13 to 24 hours, from 15 to 24 hours, from 17 to 24 hours, from 19 to 24 hours, from 21 to 24 hours, from 1 to 22 hours, from 3 to 22 hours, from 5 to 22 hours, from 7 to 22 hours, from 9 to 22 hours, from 11 to 22 hours, from 13 to 22 hours, from 15 to 22 hours, from 17 to 22 hours, from 19 to 22 hours, from 3 to 20 hours, from 5 to 20 hours, from 7 to 20 hours, from 9 to 20 hours, from 11 to 20 hours, from 13 to 20 hours, from 15 to 20 hours, from 17 to 20 hours, from 19 to 20 hours, from 3 to 18 hours, from 5 to 18 hours, from 7 to 18 hours, from 9 to 18 hours, from 11 to 18 hours, from 13 to 18 hours, from 15 to 18 hours, from 17 to 18 hours, from 3 to 16 hours, from 5 to 16 hours, from 7 to 16 hours, from 9 to 16 hours, from 11 to 16 hours, from 13 to 16 hours, from 15 to 16 hours, from 3 to 14 hours, from 5 to 14 hours, from 7 to 14 hours, from 9 to 14 hours, from 11 to 14 hours, from 13 to 14 hours, from 3 to 12 hours, from 5 to 12 hours, from 7 to 12 hours, from 9 to 12 hours, from 11 to 12 hours, from 3 to 10 hours, from 5 to 10 hours, from 7 to 10 hours, from 9 to 10 hours, from 3 to 8 hours, from 5 to 8 hours, from 7 to 8 hours, from 3 to 6 hours, from 5 to 6 hours, or from 3 to 4 hours.

In an example, the carbon quantum dots are incorporated into the biopolymer matrix at a concentration from 1 to 10% by weight, from 2 to 10% by weight, from 3 to 10% by weight, from 4 to 10% by weight, from 5 to 10% by weight, from 6 to 10% by weight, from 7 to 10% by weight, from 8 to 10% by weigh, from 9 to 10% by weight, 1 to 9% by weight, from 2 to 9% by weight, from 3 to 9% by weight, from 4 to 9% by weight, from 5 to 9% by weight, from 6 to 9% by weight, from 7 to 9% by weight, from 8 to 9% by weigh, 1 to 8% by weight, from 2 to 8% by weight, from 3 to 8% by weight, from 4 to 8% by weight, from 5 to 8% by weight, from 6 to 8% by weight, from 7 to 8% by weight, from 1 to 7% by weight, from 2 to 7% by weight, from 3 to 7% by weigh, from 4 to 7% by weight, from 5 to 7% by weight, from 6 to 7% by weight, from 1 to 6% by weight, from 2 to 6% by weight, from 3 to 7% by weight, from 4 to 6% by weight, from 5 to 6% by weight, from 1 to 5% by weight, from 2 to 5% by weight, from 3 to 5% by weight, from 4 to 5% by weight, from 1 to 4% by weight, from 2 to 4% by weight, from 2 to 3% by weight, from 1 to 3% by weight, from 2 to 3% by weight, from 1 to 2% by weight, relative to the weight of the alginate.

In an example, the cast solution drying process is conducted at room temperature, such as from about 22 to 25° C.

In an example, the cast solution drying process is conducted for a duration from 24 to 72 hours, from 30 to 72 hours, from 35 to 72 hours, from 40 to 72 hours, from 45 to 72 hours, from 48 to 72 hours, from 50 to 72 hours, from 55 to 72 hours, from 60 to 72 hours, from 65 to 72 hours, from 70 to 72 hours, 24 to 70 hours, from 30 to 70 hours, from 35 to 70 hours, from 40 to 70 hours, from 45 to 70 hours, from 50 to 70 hours, from 55 to 70 hours, from 60 to 70 hours, from 65 to 70 hours, 24 to 65 hours, from 30 to 65 hours, from 35 to 65 hours, from 40 to 65 hours, from 45 to 65 hours, from 50 to 65 hours, from 55 to 65 hours, from 60 to 65 hours, 24 to 60 hours, from 30 to 60 hours, from 35 to 60 hours, from 40 to 60 hours, from 45 to 60 hours, from 50 to 60 hours, from 55 to 60, 24 to 55 hours, from 30 to 55 hours, from 35 to 55 hours, from 40 to 55 hours, from 45 to 55 hours, from 50 to 55 hours, 24 to 50 hours, from 30 to 50 hours, from 35 to 50 hours, from 40 to 50 hours, from 45 to 50 hours, 24 to 45 hours, from 30 to 45 hours, from 35 to 45 hours, from 40 to 45 from 24 to 40 hours, from 30 to 40 hours, from 35 to 40 hours, from 24 to 35 hours, from 30 to 35 hours, or from 24 to 30 hours.

In some aspects, the packaging material has a thickness selected from 50 to 100 μm, from 60 to 100 μm, from 70 to 100 μm, from 80 to 100 μm, from 90 to 100 μm, 50 to 90 μm, from 60 to 90 μm, from 70 to 90 μm, from 80 to 90 μm, 50 to 80 μm, from 60 to 80 μm, from 70 to 80 μm, from 50 to 70 μm, from 60 to 70 μm, or from 50 to 60 μm.

### Example 1

### Synthesis of Date Seed (DS) Derived Carbon Quantum Dots (CQDs)

The packaging material described herein was synthesized by collecting date seeds, washing and drying the date seeds in an oven at 60° C. for 4 hours. After drying, seeds were ground and sieved (0.5 μm). From this, 5 g and 10 g of powder were added to the 50 mL of water, transferred into a Teflon-lined hydrothermal autoclave, and heated at 160° C. and 180° C. for 6 hours (Table 1). After cooling to room temperature, the supernatant was collected and filtered through Whatmann no.: 42 and a syringe filter (0.22 μm). After the filtration, the DS-CQDs were stored at 4° C. for further use.

TABLE 1
Synthesis of date seed (DS) derived carbon
quantum dots (CQDs) conditions.

| | Weight of DS | | |
|---|---|---|---|
| CQDs name | powder (g) | Temperature (° C.) | Duration (h) |
| DS-CQDs-0 | 5 | 160 | 6 |
| DS-CQD-1 | 5 | 180 | 6 |
| DS-CQD | 10 | 180 | 6 |

### Antioxidant Activity of DS-CQDs

The antioxidant activity of CQDs were measured using DPPH and ABTS. In the DPPH experiment, 4 mg of DPPH were added to 150 mL of ethanol. Concentrations of 12.5 g/mL, 25 g/mL, 50 g/mL, 75 g/mL, and 100 g/mL CQDs were added to 10 mL DPPH solution and incubated for 30 minutes in the dark. After that, a UV-Vis spectrophotometer measured the sample absorbances at 517 nm. The experimental control was a CQD-free test solution.

For the ABTS experiment, an aqueous solution with potassium persulfate (2.45 mM) and ABTS (7 mM) was incubated in the dark for 16 hours. The combination solution's absorbance was tuned to 1 (a.u.) at 734 nm using distilled water. Then, 10 mL of the solution were incubated with different amounts of C!Ds (12.5-25.0-100 g/mL) for 30 min in the dark before recording absorbance readings at 734 nm. The CQD-free solution was the control. The CQDs' antioxidant activity was determined using this equation:

$$Antioxidant activity ( \% ) = [ ( {A}_{o} - {A}_{T} ) \div {A}_{o} ] \times 100$$

where Aₒ and A_{T} are control and test sample absorbances.

### The Anti-Microbial and Antifungal Activity of DS-CQDs

The pathogens considered for this activity were Escherichia coli (ATCC 8739), Staphylococcus aureus (ATCC 6538), Pseudomonas aeruginosa (ATCC 853), Bacillus subtilis (ATCC 6633), and Candida albicans (ISM 76/3).

A fresh inoculum of bacterial species was prepared by inoculating the 10 μL of each bacterial and fungal pathogenic solution into the Brain Heart Infusion (BHI) broth and incubating the pathogens at 37° C. for 16 hours in an incubator shaker. 100 μL of the bacterial solution was spread and inoculated on solidified agar media in Petri plates and made wells. Following this, wells of 100 μL capacity were bored into the media, and an equal volume of DS-CQDs solution was added to each well. The plates were incubated for 16 hours at 37° C., after which the zone of inhibition was determined in millimeters. An antibiotic called gentamycin was also placed alongside wells as a control.

### Preparation of Alginate/DS-CQDs Loaded Films

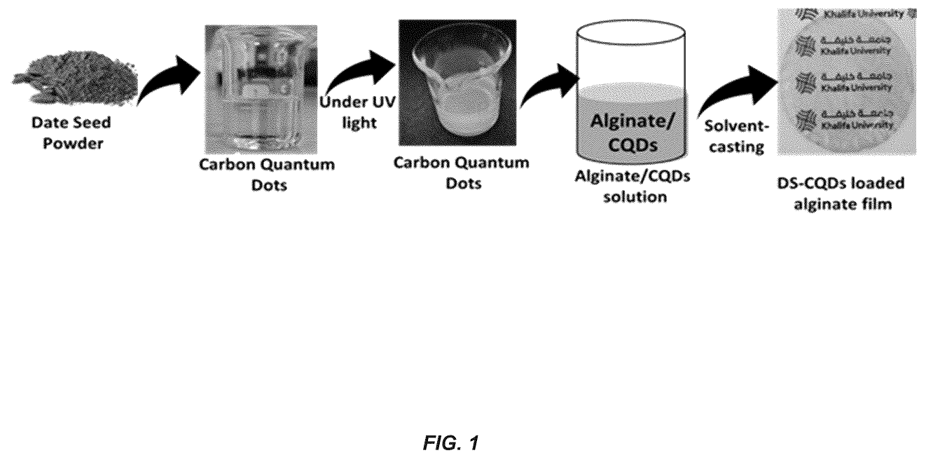

The preparation of alginate/DS-CQDs loaded films required dissolving 4 g sodium alginate and 1.2 g glycerol in 200 mL of distilled water at 90° C. for 1 hour. Depending on the weight of the alginate, DS-CQDs (0, 2, 4, and 6 wt %) were vigorously mixed into the alginate solution. Later, the film solution was cast onto a Teflon film-coated glass plate and dried at room temperature for 48 hours (FIG. 1). After peeling the dry films from the plates, films were conditioned in a humidity room at 25° C. and 50% RH for 72 h before testing. These films were named Alg, Alg/DS-CQDs 2%, Alg/DS-CQDs 4%, and Alg/DS-CQDs 6%.

### Antioxidant Activity of Alg/DS-CQDs Loaded Films

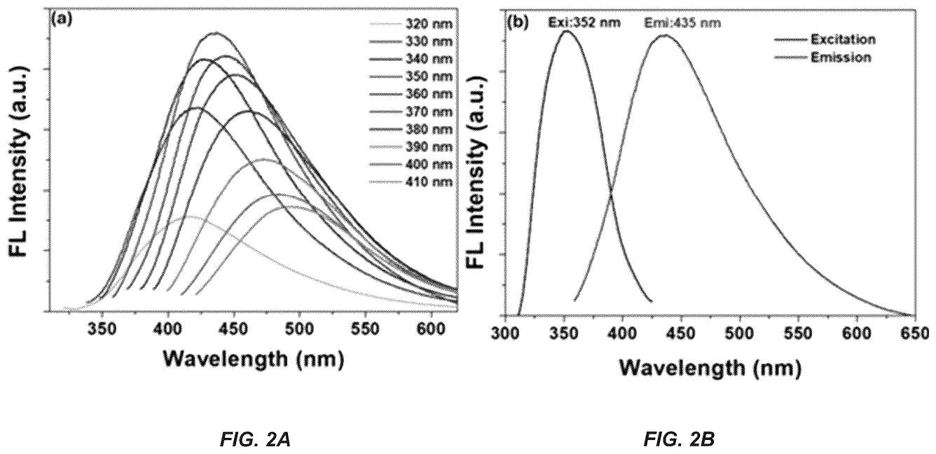

The antioxidant activity of the film was evaluated using the DPPH and ABTS free radical scavenging methods. The DPPH and ABTS solutions were prepared as mentioned in previous sections. 50 mg of each film sample was added to 10 mL DPPH and ABTS solutions and incubated for 30 min in the dark before recording the absorbance at 517 and 734 nm, respectively, using a UV-visible spectrophotometer (FIGS. 2A-B).

### Color Properties of the Film

Lab-scale hand-held colorimeters (PCE-CSM 5, PCE Instruments, Southampton, UK) measured sample colors. As per the manufacturer, the colorimeter was calibrated with white and black tile standards, used a D65 (6500 K) light source, and recorded the ‘L’, ‘a’ and ‘b’ values.

### Water Vapor Transmission Rate (WVTR)

The WVTR of the bio-nanocomposite films adopts the American Society for Testing and Materials (ASTM) method E96-95 and made some changes. Each film was carefully placed on top of a water test cell, which was placed inside a regulated chamber with a saturated sodium chloride solution to maintain a temperature of 25° C. and a relative humidity of 75%. The weight variation was measured after a three-day exposure period.

The weight of the bottle was recorded every 24 hours for a total of 72 hours. The WVTR used the following formula to calculate

$$WVTR = \frac{1}{A} ( \frac{Δ W}{t} )$$

ΔW, represents the weight change of the cell (g); t is the time(s); A is the test area (m²).

### Results and Discussion

### Antioxidant Activity of the Date Seed Powder-Derived CQDs

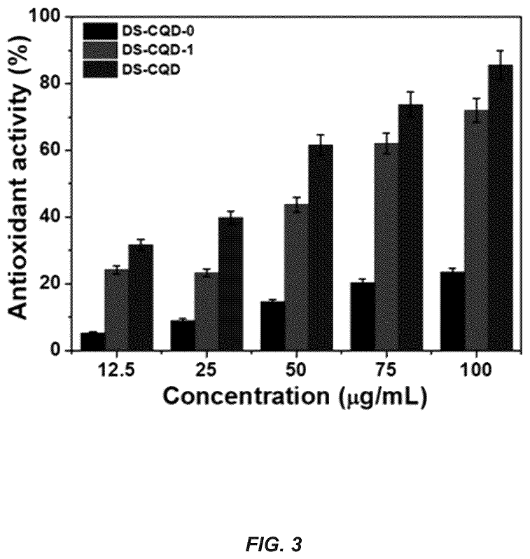

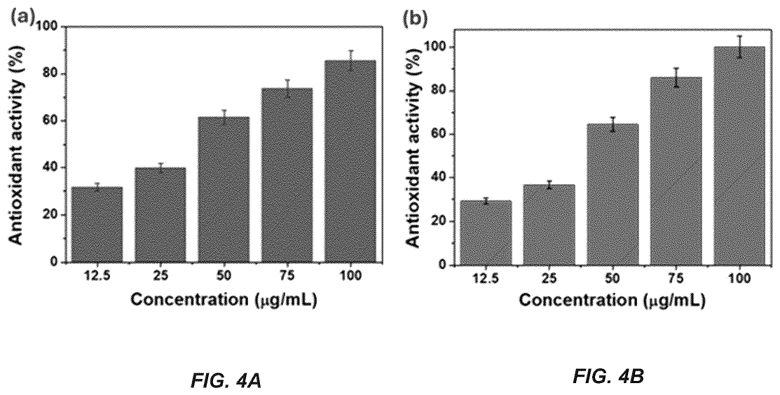

The antioxidant activity of the DS-CQDs prepared at different synthesis conditions was evaluated using a DPPH assay. The results show that the scavenging potential of CQDs varied with respect to the synthesized condition; the scavenging potential against DPPH was as follows: 23.55% (DS-CQD-0), 72.05% (DS-CQD-1), and 85.57% (DS-CQD) (FIG. 3). Among them, DS-CQD displayed the highest scavenging potential against DPPH, possibly due to the release of active polyphenolic contents into the supernatant solution at increased temperature conditions and date seed powder concentration. The active polyphenolic contents were coming into the supernatant solution. To further explore the antioxidant potential of DS-CQDs, another antioxidant assay called ABTS assay was utilized, and the antioxidant activity was performed. FIGS. 4A-B show the ABTS assay of the DS-CQDs. The results show that with increasing concentration of CQDs, the scavenging potential was increased, and the maximum scavenging potential (100%) was observed at 100 μg/mL concentration. The difference in scavenging potential was due to the difference in solvents used for the assay. The release of the CQDs into the aqueous medium was much stronger than organic solvents due to the hydrophilicity of the CQDs. Therefore, the ABTS method in aqueous solution for CQD has better antioxidant activity than the DPPH approach in ethanol.

### Antimicrobial Activity of DS-CQDs

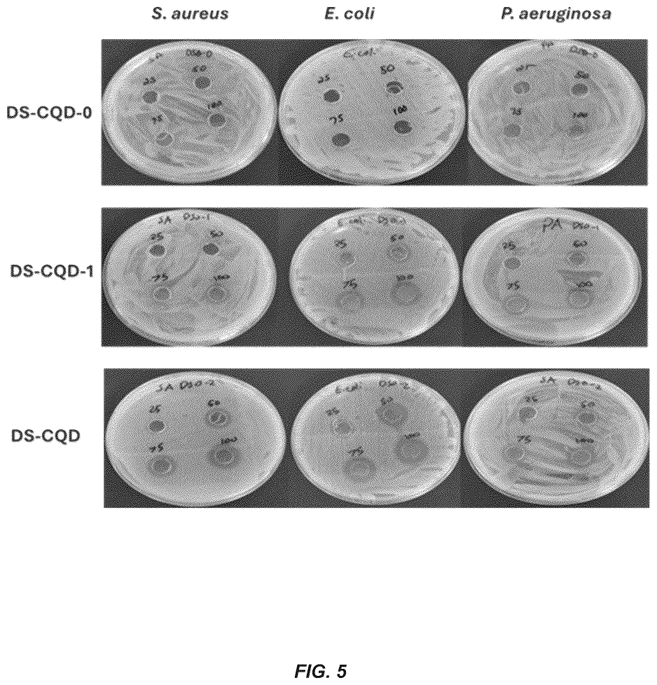

The preliminary well diffusion assay results indicated that the CQDs prepared at different synthesis conditions displayed differences in their activity. The DS-CQD displayed zone formation against CQDs prepared against E. coli, S. aureus, and P. aeruginosa (FIG. 5).

DS-CQDs-0 did not display an antibacterial effect by displaying the no-zone formation around the well. The DS-CQD-1 displayed their activity against all three species only at the highest volume of (100 μL) of CQDs. However, DS-CQD displayed a zone against all three bacterial species even at the lowest volume of the CQDs (25 μL). While not wanting to be bound by the following statement, this might be due to the release of antimicrobial agents from the date seed under the performed synthesis conditions. This result indicated that the date seed-derived CQDs, synthesized at 180° C./6 hours condition, displayed better antimicrobial properties against the pathogens. Also, the DS-CQD-1 displayed the zone only against E. coli and P. aeruginosa, and no zone formation was observed against S. aureus (FIG. 5).

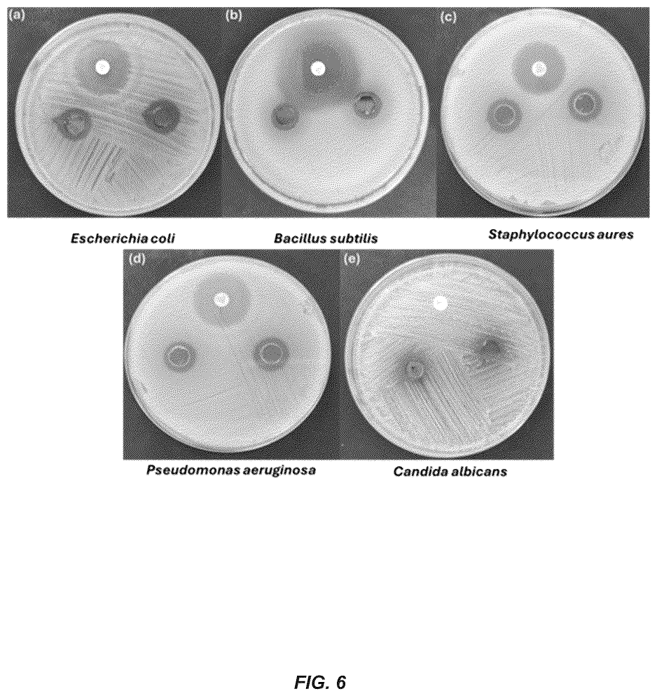

However, the DS-CQD displayed a zone of inhibition against all three bacterial pathogens. The activity was extended against Bacillus subtilis and Candida albicans to evaluate its antibacterial potential (FIG. 6). The well diffusion results and zone size are represented in Table 2. The DS-CQDs confirmed its antibacterial potential against all the supplied bacteria at a concentration of 2.8 mg/100 μL per well. Based on the antioxidant and antibacterial activity results, DS-CQDs were chosen to develop the packaging film for mushroom packaging.

TABLE 2
Zone of inhibition of DS-CQDs against bacterial strains

| Pathogen | Zone of inhibition (mm) |
|---|---|
| E. coli | 14.5 ± 0.7 |
| S. aureus | 14.87 ± 0.25 |
| P. aeruginosa | 12.75 ± 0.9 |
| B. subtilis | 13.35 ± 0.6 |
| C. albicans | 12 ± 0.0 |

### Properties of Alg/DS-CQDs Films

### Antioxidant Activity:

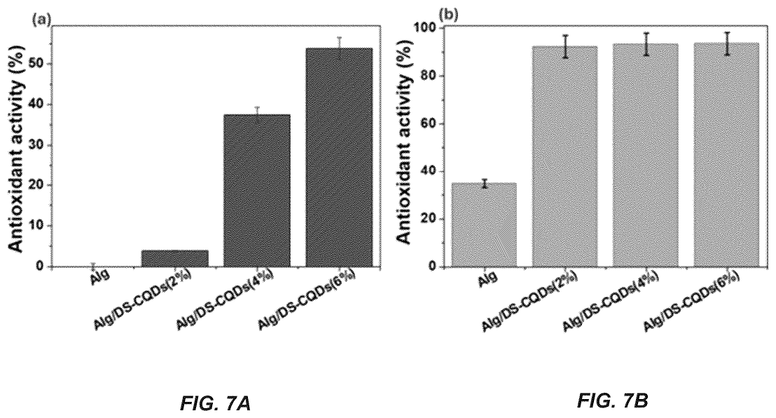

Antioxidant or radical scavenging activity reveal a substance's radical inhibition or scavenging capacity in a radical-generating agent. DPPH and ABTS techniques revealed CQD antioxidant activity (FIGS. 7A-B). The DS-CQDs-added films showed significant DPPH scavenging activity when compared to the neat Alg film, where the Alg/DS-CQD-2% film showed 3.7%, Alg/DS-CQD-4% displayed 37.4% and, Alg/DS-CQD-6% film showed 53.8% antioxidant activity (FIG. 7A). In the ABTS method, the neat alginate film displayed insignificant scavenging activity, and DS-CQD loaded 2%, 4%, and 6% films displayed similar scavenging potential significantly from 92.2, 93.2, and 93.5%, respectively (FIG. 7B). Here, the antioxidant activity in the neat alginate film (31% of ABTS activity) was due to the reaction of exposed electron-donating hydroxyl groups in alginate with ABTS free radicals over time. The low antioxidant activity of the film in the DPPH method was due to the limited release of the active ingredient (i.e., CQDs) into a nonpolar methanol solution in the DPPH method.

### Color Properties of Films

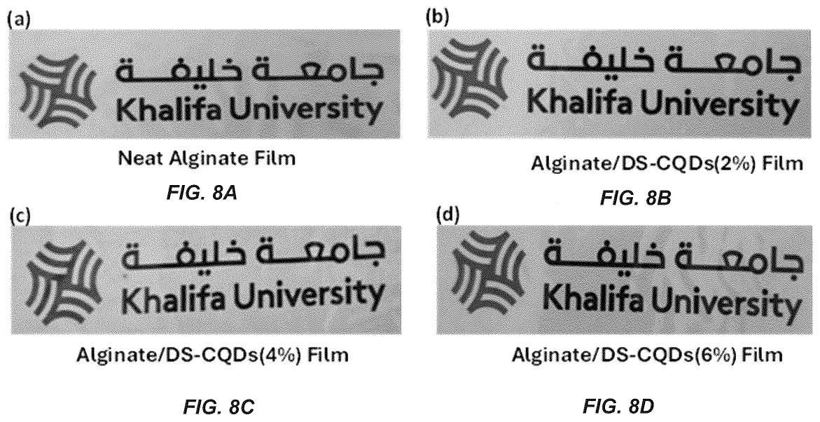

Neat Alg film was translucent and colorless (FIG. 8A). After adding DS-CQDs, the films turned yellow (FIGS. 8B-D). Table 3 shows the DS-CQD-added Alg films' color properties. Increasing the loading concentration of DS-CQDs from 2% to 6% lowered the film's lightness. The films' redness (‘a’ value) and yellowness (‘b’ value) also steadily rose. With an increasing percentage of DS-CQDs, films ‘a’ and ‘b’ values increased gradually.

TABLE 3
Apparent color properties of the Alginate-based films.

| | | | | Thick- |
|---|---|---|---|---|
| Sample | L | a | b | ness(μm) |
| Alg | 94.54 ± 0.23^{a} | 0.27 ± 0.04^{a} | 4.26 ± 0.56^{a} | 55 ± 0.0^{a} |
| Alg/DS- | 88.22 ± 0.39^{b} | 1.33 ± 0.05^{b} | 12.59 ± 0.38^{b} | 57.4 ± 0.00^{b} |
| CQD 2% | | | | |
| Alg/DS- | 83.23 ± 1.06^{c} | 3.27 ± 0.42^{c} | 19.89 ± 0.98^{c} | 66.4 ± 0.01^{c} |
| CQD 4% | | | | |
| Alg/DS- | 75.57 ± 0.23^{d} | 6.70 ± 0.16^{d} | 30.25 ± 0.22^{d} | 87.6 ± 0.01^{d} |
| CQD 6% | | | | |

Each value presents the mean of three replicates±standard deviation. Any two means in the same column followed by the same letter were not significantly different from each other (p>0.05) by Duncan's multiple-range test.

### Water Vapor Transmission Rate (WVTR)

WVTR has been reported to be the most important parameter of the films, and it has a handy role in determining the shelf-life improvement of packaged food products. This characteristic indicates the transfer of moisture with the environment. Hence, maintaining the WVTR in films is of great interest, and WVTR results associated with the films developed from the CQDs are shown in Table 4. WVTR of the films with or without adding CQDs was observed to follow a decreasing trend with respect to the time; however, this decrease was found at a slower rate than the control film. Moreover, in the case of DS-CQDs loaded films, the WVTR decreased at a lower rate with an increase in the concentration of DS-CQDs from 2 to 6%, which maintained a moisture flow through the treated films throughout the shelf life compared to the control film. This means the WVTR is controlled with respect to the time in the 6% Alg/DS-CQDs films. After 48 h, the 6 wt % loaded Alg/DS-CQD-film shows only 80% water vapor permeability compared to alginate (95%). This means that the spatial arrangements of DS-CQDs within the matrix created a pathway for the controlled release of water vapor. Due to this reason, the 6% DS-CQDs loaded films have reduced water vapor transmission with respect to the time compared to the remaining films.

TABLE 4
WVTR of Alg and Alg/DS-CQDs films.

| | WVTR (10⁻⁸ gcm⁻²s⁻¹) | | |
|---|---|---|---|
| Sample | 2-24 hrs | 24-48 hrs | 48-72 hrs |
| Alg | 2.876 ± 0.04^{a} | 0.234 ± 0.05^{a} | 0.117 ± 0.03^{a} |
| Alg/DS-CQD 2% | 3.145 ± 0.06^{ab} | 0.892 ± 0.04^{b} | 0.563 ± 0.01^{b} |
| Alg/DS-CQD 4% | 3.765 ± 0.03^{b} | 1.034 ± 0.07^{bc} | 0.651 ± 0.08^{bc} |
| Alg/DS-CQD 6% | 4.954 ± 0.02^{c} | 1.437 ± 0.01^{d} | 0.983 ± 0.04^{d} |

Different superscript letters in the same column represent significant (p<0.05) differences among the films.

### Spoilage Monitoring

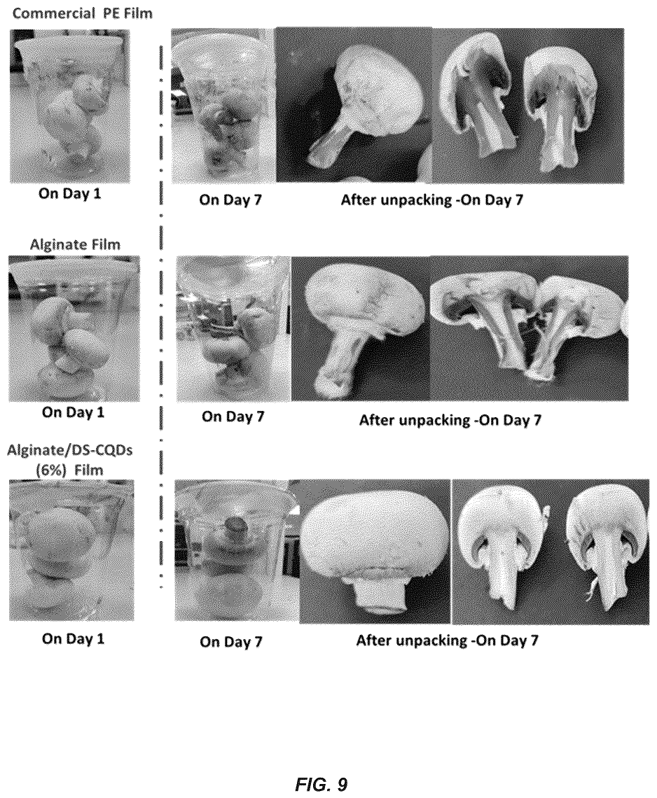

The spoilage was visually monitored over seven days at 22° C. (FIG. 9). Among (2, 4, and 6%) three different loadings of DS-CQDs of alginate films, the 6% loaded alginate films kept the freshness of mushrooms for 7 days.

### CONCLUSION

Given mushrooms' high respiration and transpiration rates, they require a controlled atmosphere to prevent rapid spoilage. CQD-incorporated alginate films effectively regulated gas exchange and prevented moisture buildup, successfully maintaining mushroom freshness without unpleasant odor for up to seven days at room temperature.

In contrast, mushrooms in commercial PE packaging developed foul odors, spoilage, and textural loss. PE film packaging limits water vapor permeability, causing moisture buildup and condensation within 48 hours at room temperature, which encourages spoilage within five days by fostering spore growth. These findings suggest that date seed-derived CQDs (6%) incorporated active alginate films exhibit a controlled water vapor permeability, which can extend mushroom shelf life by preventing spoilage and preserving freshness at ambient temperatures.

This study shows that CQDs derived from date seed waste serve as effective nanofillers in alginate films, significantly slowing spoilage and extending the shelf life of Agaricus bisporus mushrooms to seven days at 22° C.

What is claimed is:

1. A packaging material comprising:
a) carbon quantum dots; and
b) a biopolymer matrix;
wherein the carbon quantum dots are uniformly dispersed within the biopolymer matrix; and
wherein the packaging material is biodegradable.

2. The packaging material of claim 1, wherein the carbon quantum dots comprise a particle size from 1 to 10 nm.

3. The packaging material of claim 1, wherein the carbon quantum dots comprise an excitation-dependent fluorescence emission property in 300-410 nm and displayed maximum emission intensity at 435 nm with an excitation energy of 352 nm.

4. The packaging material of claim 1, wherein the biopolymer matrix comprises an alginate.

5. The packaging material of claim 1, wherein the packaging material has a thickness from 5 μm to 100 μm.

6. A method for producing a packaging material, the method comprising:
a) synthesizing carbon quantum dots using a hydrothermal process;
b) incorporating the carbon quantum dots into a biopolymer matrix comprising an alginate to form a carbon quantum dots-loaded biopolymer solution;
c) casting the carbon quantum dots-loaded biopolymer solution onto a PTFE-film coated glass plate to create a cast solution; and
d) drying the cast solution to produce a packaging material film.

7. The method of claim 6, wherein the carbon quantum dots are derived from a date seed.

8. The method of claim 6, wherein the carbon quantum dots are synthesized by subjecting the date seed to the hydrothermal process at a temperature from 100 to 200° C.

9. The method of claim 6, wherein the hydrothermal process is conducted for a duration from 1 to 24 hours.

10. The method of claim 6, wherein the carbon quantum dots are incorporated into the biopolymer matrix at a concentration from 2 to 6% by weight relative to the weight of the alginate.

11. The method of claim 6, further comprising dispersing the carbon quantum dots uniformly into the biopolymer matrix using mechanical stirring.

12. The method of claim 6, wherein the cast solution drying process is conducted at room temperature.

13. The method of claim 12, wherein the cast solution drying process is conducted for a duration from 48 to 72 hours.

14. The method of claim 6, wherein the packaging material has a thickness selected from 50 μm to 100 μm.

15. The method of claim 6, wherein the packaging material film is biodegradable.

16. A method for preparing a packaging material, the method comprising:
a) subjecting a date seed to a hydrothermal process to synthesize carbon quantum dots;
b) dispersing the carbon quantum dots into a biopolymer matrix comprising an alginate to form a carbon quantum dots-loaded biopolymer solution;
c) casting the carbon quantum dots-loaded biopolymer solution onto a PTFE-film coated glass plate to create a cast solution; and
d) drying the cast solution to synthesize a packaging material.

17. The method of claim 16, wherein the carbon quantum dots are synthesized by subjecting the date seed to the hydrothermal process at a temperature from 100 to 200° C.

18. The method of claim 16, wherein the hydrothermal process is conducted for a duration from 1 to 24 hours.

19. The method of claim 16, wherein the carbon quantum dots are incorporated into the biopolymer matrix at a concentration from 1% to 10% by weight relative to the weight of the alginate.

20. The method of claim 16, further comprising dispersing the carbon quantum dots uniformly into the biopolymer matrix using mechanical stirring.
